(19) United States
(12) Patent Application Publication
(10) Pub. No.: US 2015/0039364 A1
(43) Pub. Date: Feb. 5, 2015

(54) OPTIMIZING EMERGENCY RESOURCES IN CASE OF DISASTER

(71) Applicant: International Business Machines Corporation, Armonk, NY (US)

(72) Inventors: Vincent Beraudier, Grasse (FR); Georges-Henri Moll, Villeneuve-Loubet (FR)

(21) Appl. No.: 14/306,482

(22) Filed: Jun. 17, 2014

(30) Foreign Application Priority Data
Jul. 31, 2013 (GB) 1313712.0

(51) Int. Cl. G06Q 10/06; G06Q 50/30; G06Q 10/04

(52) U.S. Cl. CPC G06Q 10/06311; G06Q 10/04; G06Q 50/30
USPC 705/7.13

(57) ABSTRACT

A method and system for planning relocation of people from disaster locations to safe locations. Received are an identification of: a disaster locations at which a respective disaster is predicted to occur, numbers of persons to be evacuated during a specified range of time at each disaster location, safe locations available for relocating the persons to be evacuated, vehicles available to transport the persons from the disaster locations to the safe locations, each vehicle's capacity of a maximum number of people that can be simultaneously transported, and each vehicle's current location. An optimal plan is generated for (i) evacuating the identified number of persons from the disaster locations during the respective specified ranges of time and (ii) transporting the evacuated persons to the safe locations, utilizing the received identifications. All persons evacuated from the disaster locations have been relocated at the safe locations by elapse of the N time intervals.

### TECHNICAL FIELD

The present invention relates to computer-implemented optimization of emergency resources in case of disaster, which may include the use of mixed-integer programming to compute an evacuation plan using emergency resources in case of disaster.

### BACKGROUND

A data processing system for management of disasters typically comprises four steps.

A first step is the prediction of a disaster. According to The International Federation of Red Cross and Red Crescent Societies (IFRC) disasters may be naturally occurring physical phenomena caused either by rapid or slow onset events which can be geophysical (earthquakes, landslides, tsunamis and volcanic activity), hydrological (avalanches and floods), climatological (extreme temperatures, drought and wildfires), meteorological (cyclones and storms/wave surges) or biological (disease epidemics and insect/animal plagues). Also according to IFRC, disasters may also be technological or man-made hazards (complex emergencies/conflicts, famine, displaced populations, industrial accidents and transport accidents) are events that are caused by humans and occur in or close to human settlements. This can include environmental degradation, pollution and accidents. Prediction of each type of disaster may be different, but is well known to a person skilled in the art.

A second step is to determine the impact of the disaster on the area where the disaster occurs. The impact may be that certain facilities, people or vehicles may become unavailable. It may also require people, vehicles or resources to be moved from an area affected by the disaster to areas unaffected by the disaster. Determination of the impact of a disaster on an area is also well known to a person skilled in the art.

A third step is to predict or simulate the traffic impact on the area of the disaster where vehicular traffic is possible. When a disaster occurs, there will be additional traffic due to people evacuating themselves from the area and due to official evacuation from an area. There may further be traffic from official provision of assistance to the area and also from unofficial provision of assistance, such as, for example, by relatives and friends travelling to an area to search for and provide assistance to victims. Such prediction or simulation of the traffic impact on the area of the disaster is also well known to a person skilled in the art.

A fourth step is to compute an evacuation (delivery/pickup) plan. The purpose of this plan is to evacuate people from areas affected by the disaster to areas that are not affected by the disaster, with an aim of avoiding a new concentration of people in the areas that are not affected by the disaster. Although the computation of such evacuation plans is known to persons skilled in the art, the present patent application discloses improved methods, systems and computer programs for the computation of such evacuation plans.

“A Generalized Hypercube Queuing Model for Locating Emergency Response Vehicles in Urban Transportation Networks”, by Geroliminis et al., 85th Annual Meeting Transportation Research Board, Washington, D.C., January 2006 discloses that emergency response systems in urban areas should be located in such a way to ensure adequate coverage as well as a rapid response time. A model is disclosed for locating emergency vehicles on urban networks based on a generalization of the Hypercube Queuing Model. The model considers spatial and temporal characteristics of demand such as the possibility that a server is not always available when its service is required, and the service rates are not identical and may be variable both among servers and incident characteristics.

“Emergency service systems: The use of the hypercube queuing model in the solution of probabilistic location problems”, Roberto D Galvão, Reinaldo Morabito, International Transactions in Operational Research (2008), Volume: 15, Issue: 5, Publisher: Blackwell Publishing Ltd, Pages: 525-549, discloses that probabilistic location problems are surveyed from the perspective of their use in the design of emergency service systems, with special emphasis on emergency medical systems. Pioneering probabilistic models were defined in the 1980s, as a natural extension of deterministic covering models (first generation models) and backup models (second generation). These probabilistic models, however, adopted simplifying assumptions that in many cases do not correspond to real-world situations, where servers usually co-operate and have specific individual workloads. Thus the idea of embedding the hypercube queuing model into these formulations is to make them more adherent to the real world. The hypercube model and its extensions are initially presented in some detail, which is followed by a brief review of exact and approximate methods for its solution.

The problem addressed by the two pieces of prior art above is that of having an input of a history independent forecasting model (typically a Poisson model) of emergencies. An output of a quasi optimal location for vehicles and personnel to wait for an emergency is calculated, so that the expected response time to an emergency is a minimal time. When an actual emergency happens, no planning needs to be done. The closest resource is sent to fulfil the emergency. No shared resource competition and skills overlap are considered. Emergencies are dealt with individually. The two pieces of prior art above concern deciding on the best waiting location for personnel and vehicles for single emergencies.

The disclosures of the prior art identified above and of the fourth step identified above are complementary. One has to first decide where to locate emergency resources before an emergency or catastrophe happens, before actually deciding the routing, pickup and delivery in case of multiple emergencies (catastrophe case).

“Decision Models for Emergency Response Planning”, Larson, R., Metzger, M., & Cahn, M., CREATE REPORT, 28 Sep. 2004, at http://create.usc.edu/research/50755.pdf discloses prioritizing dispatching rules, which is after the step four above of planning, that is, actually executing a plan, and adapting to the last minute changes that may occur. It also discloses the Hypercube model already discussed with regard to the above prior art references. One application of the Hypercube approach is fire department relocation. It further discloses the actual arbitration of shared resource in the case of earthquake. The resource distribution algorithm involves only two locations, modelled as two geographic points. The algorithm is a heuristic (as opposed to mixed integer programming (MIP)) one that iteratively estimates the number of lives to be saved and send rescuers proportionally. The estimated number of lives to be saved at each iteration of the algorithm is based on the actual number of lives saves compared with the number of expected lives to remain, according to a static probabilistic model. In summary, the disclosure is of (i) a two points geographic model; (ii) a heuristic based algorithm, rather than a OR/MIP based algorithm; and (iii) the forecasting model is static, which is indeed appropriate to an earthquake, but in a case of flooding it may not be possible to anticipate the emergencies a few time buckets (hours typically) in advance.

### BRIEF SUMMARY

The present invention provides a method, and associated computer program product and computer system, for planning relocation of people from disaster locations to safe locations, said method comprising:

receiving, by a processor of a computer system, an identification of: a plurality of disaster locations at which a respective disaster is predicted to occur, a number of persons to be evacuated during a specified range of time at each disaster location, a plurality of safe locations available for relocating the persons to be evacuated from the disaster locations, a plurality of vehicles available to transport the persons from the disaster locations to the safe locations, each vehicle's capacity of a maximum number of people that can be simultaneously transported, and each vehicle's current location; and

generating, by the processor, an optimal plan for (i) evacuating the identified number of persons from the disaster locations during the respective specified ranges of time and (ii) transporting the evacuated persons to the safe locations,

said generating the plan comprising utilizing the received identifications, as input, to determine, for each time interval of N successive time intervals such that N is at least 2: (a) a location of each vehicle relative to the disaster locations and the safe locations and (b) a number of persons in each disaster location, each vehicle, and each safe location,

wherein all persons evacuated from the disaster locations have been relocated to the safe locations by elapse of the N time intervals.

### BRIEF DESCRIPTION OF THE DRAWINGS

FIG. 1 shows a map of a city surrounded by water, in accordance with embodiments of the present invention.

FIG. 2 shows the map of FIG. 1 annotated with the resources of each stakeholder, in accordance with embodiments of the present invention.

FIG. 3 shows a flowchart of the four basic steps of a disaster management system, the fourth step being implemented in embodiments of the present invention, in accordance with embodiments of the present invention.

FIGS. 4A-4H show an Entity-Relationship data model of an embodiment of the present invention, in accordance with embodiments of the present invention.

FIG. 5 shows the map of FIG. 1 annotated with an actual or forecast disaster, in accordance with embodiments of the present invention.

FIG. 6 shows the map of FIG. 1 annotated with the locations of people to save, in accordance with embodiments of the present invention.

FIG. 7 shows a simplified example of an evacuation, in accordance with embodiments of the present invention.

FIG. 8 shows a system comprising the Entity-Relationship model of FIG. 10 together with an MIP engine, in accordance with embodiments of the present invention.

FIG. 9 illustrates a computer system used for implementing the methods of the present invention, in accordance with the embodiments of the present invention.

FIG. 10 depicts an Entity-Relationship model, in accordance with the embodiments of the present invention.

### DETAILED DESCRIPTION

Disclosed is a computer-implemented, mixed-integer-programming-based method to compute an evacuation plan for optimising the scheduling and use of resources to evacuate people from a disaster event. The method comprises providing as input, in a machine-readable data format, a catastrophe identifier with type and location information; a list of personnel with type and initial location information and counts for each unique type of personnel; a list of vehicles with initial location information and unique IDs for each vehicle; a list of facilities with type and location information; and a list of victims with situation and location information. Data processing in a computer is employed to analyze schedules and resources over a plurality of time periods to evacuate people from a disaster event from unavailable portions of an area near to a disaster to available portions of an area away from a disaster, involving trips, people moves, emergency and medical actions. Output is produced, in a machine-readable data format, for each possible catastrophe, time, trip and catastrophe procedure, an indication of the magnitude of the performed action; for each person in said list of personnel, type and location information; for each vehicle in said list of vehicles, type and location information; for each facility in said list of facilities, occupancy level, number of exits and number of planned exits; for each group of victims in said list of victims, type and location information and a count of the number of victims in the group of victims; for each group of victims in said list of victims, action information including identifiers for trips including approach trips and evacuation trips, victim procedure identifier and number of treated victims; for each said trip, a trip identifier, vehicle type used for said trip, start and destination identifiers, number of vehicles involved and duration; for each said trip, a trip identifier, a victim type identifier and a number of victims; and for each said trip, a trip identifier, a personnel type identifier and a number of personnel.

Embodiments of the present invention provide a computer-implemented, mixed-integer-programming-based method to compute an evacuation plan for optimising the scheduling and use of resources to evacuate people from a disaster event, the method comprising the steps of: providing as input, in a machine-readable data format, a catastrophe identifier with type and location information; providing as input, in a machine-readable data format, a list of personnel with type and initial location information and counts for each unique type of personnel; providing as input, in a machine-readable data format, a list of vehicles with initial location information and unique IDs for each vehicle; providing as input, in a machine-readable data format, a list of facilities with type and location information; providing as input, in a machine-readable data format, a list of victims with situation and location information; employing data processing in a computer to analyze schedules and resources over a plurality of time periods to evacuate people from a disaster event from unavailable portions of an area near to a disaster to available portions of an area away from a disaster, involving trips, people moves, emergency and medical actions; producing as output, in a machine-readable data format, for each possible catastrophe, time, trip and catastrophe procedure, an indication of the magnitude of the performed action; producing as output, in a machine-readable data format, for each person in said list of personnel, type and location information; producing as output, in a machine-readable data format, for each vehicle in said list of vehicles, type and location information; producing as output, in a machine-readable data format, for each facility in said list of facilities, occupancy level, number of exits and number of planned exits; producing as output, in a machine-readable data format, for each group of victims in said list of victims, type and location information and a count of the number of victims in the group of victims; producing as output, in a machine-readable data format, for each group of victims in said list of victims, action information including identifiers for trips including approach trips and evacuation trips, victim procedure identifier and number of treated victims; producing as output, in a machine-readable data format, for each said trip, a trip identifier, vehicle type used for said trip, start and destination identifiers, number of vehicles involved and duration; producing as output, in a machine-readable data format, for each said trip, a trip identifier, a victim type identifier and a number of victims; and producing as output, in a machine-readable data format, for each said trip, a trip identifier, a personnel type identifier and a number of personnel.

In embodiments of the present invention, said step of employing data processing in a computer to analyze schedules and resources over a plurality of time periods operates in a schedule mode, in which the resources to achieve given objectives are provided as input and a shortest schedule is produced as output.

In embodiments of the present invention, said step of employing data processing in a computer to analyze schedules and resources over a plurality of time periods operates in a resource sizing mode, in which the time by when the evacuation has to be completed is provided as an input and a smallest number of resources is produced as an output whilst still respecting the time constraints.

In embodiments of the present invention, the method further comprises the step of providing as input, in a machine-readable data format, actual real-time traffic data.

In embodiments of the present invention, the method further comprises the step of providing as input, in a machine-readable data format, predicted real-time traffic data.

Embodiments of the present invention further provide a system employing mixed-integer-programming-based method to compute an evacuation plan for optimising the scheduling and use of resources to evacuate people from a disaster event, comprising: means for providing as input, in a machine-readable data format, a catastrophe identifier with type and location information; means for providing as input, in a machine-readable data format, a list of personnel with type and initial location information and counts for each unique type of personnel; means for providing as input, in a machine-readable data format, a list of vehicles with initial location information and unique IDs for each vehicle; means for providing as input, in a machine-readable data format, a list of facilities with type and location information; means for providing as input, in a machine-readable data format, a list of victims with situation and location information; means for employing data processing in a computer to analyze schedules and resources over a plurality of time periods to evacuate people from a disaster event from unavailable portions of an area near to a disaster to available portions of an area away from a disaster, involving trips, people moves, emergency and medical actions; means for producing as output, in a machine-readable data format, for each possible catastrophe, time, trip and catastrophe procedure, an indication of the magnitude of the performed action; means for producing as output, in a machine-readable data format, for each person in said list of personnel, type and location information; means for producing as output, in a machine-readable data format, for each vehicle in said list of vehicles, type and location information; means for producing as output, in a machine-readable data format, for each facility in said list of facilities, occupancy level, number of exits and number of planned exits; means for producing as output, in a machine-readable data format, for each group of victims in said list of victims, type and location information and a count of the number of victims in the group of victims; means for producing as output, in a machine-readable data format, for each group of victims in said list of victims, action information including identifiers for trips including approach trips and evacuation trips, victim procedure identifier and number of treated victims; means for producing as output, in a machine-readable data format, for each said trip, a trip identifier, vehicle type used for said trip, start and destination identifiers, number of vehicles involved and duration; means for producing as output, in a machine-readable data format, for each said trip, a trip identifier, a victim type identifier and a number of victims; and means for producing as output, in a machine-readable data format, for each said trip, a trip identifier, a personnel type identifier and a number of personnel.

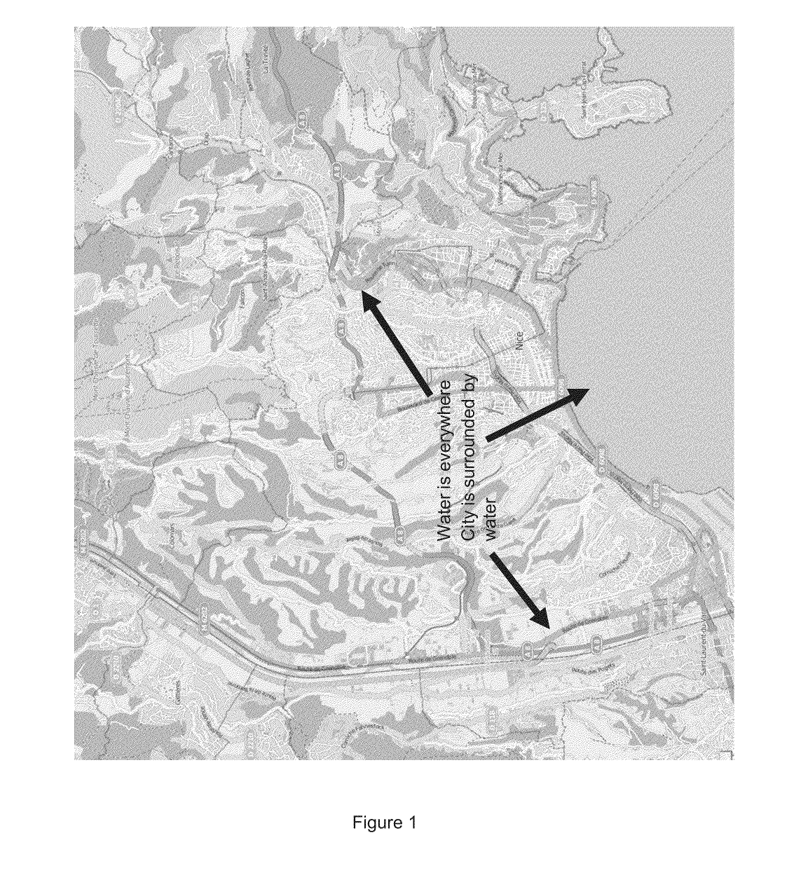

Referring to FIG. 1, a map of a city surrounded by water is shown as an example of a city that may suffer from a disaster, in accordance with embodiments of the present invention. The city shown is Nice in France, but embodiments of the present invention are not limited to this city or country, or even to a city itself. Embodiments of the present invention are equally applicable to areas, such as countryside, mountains or the like. The example in FIG. 1 is of a city surrounded by water, but it could be a city, countryside or the like which is close to any other source of a disaster, such as those identified by the IFRC and mentioned in the background above. In FIG. 1, the water shown is the sea on one side and the Var and Paillon Rivers on two other sides.

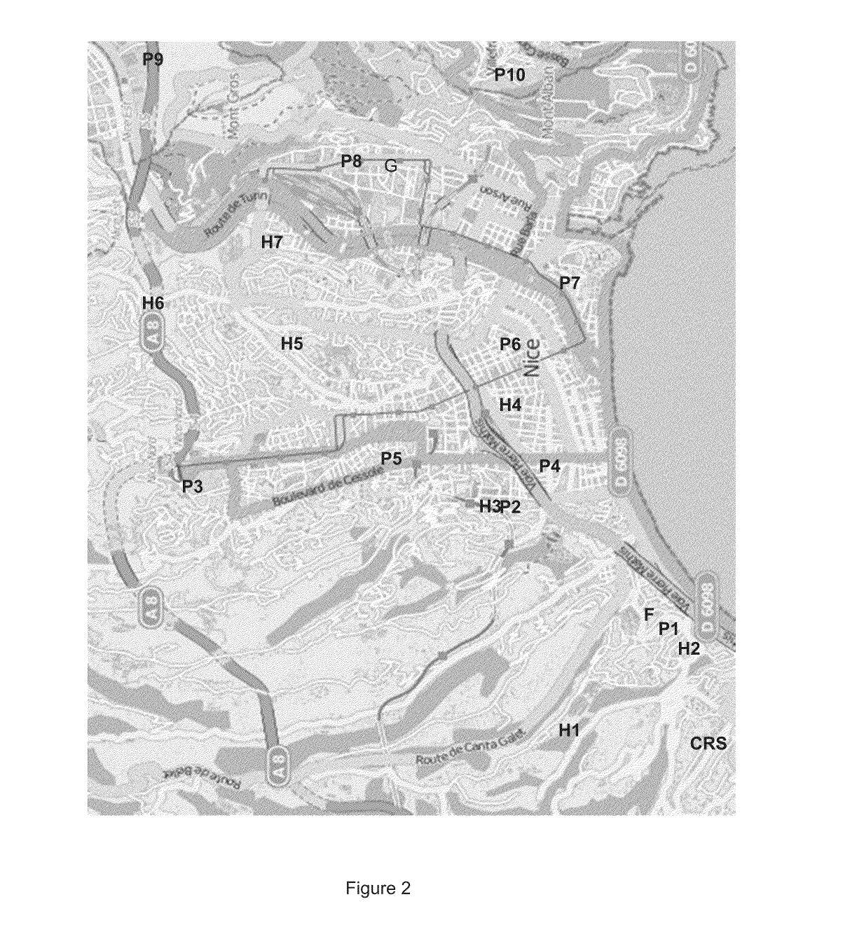

Referring to FIG. 2, the map of FIG. 1 is annotated with the resources of each stakeholder. Hospitals H1 to H7, police departments P1 to P10, fire department F and Coastal rescue Service CRS are shown, in accordance with embodiments of the present invention. Exemplary numbers of people and equipment at some of the identified locations might include the following:

| | | | | |
|---|---|---|---|---|
| H1 | 25 doctors | 50 nurses | 125 patients | 30 ambulances |
| H5 | 20 doctors | 50 nurses | 200 patients | 20 ambulances |
| H7 | 5 doctors | 25 nurses | 100 patients | 5 ambulances |

| | | | |
|---|---|---|---|
| P3 | 25 men | | 15 cars |
| P8 | 30 men | | 10 cars |
| F | 80 men | 5 buses | 20 fire appliances |
| CRS | 100 soldiers | 20 buses | 1 helicopter |

The hospitals H1 to H7 in FIG. 2 are examples safe locations to which people evacuated from disaster locations may be transported.

Embodiments of the present invention are not restricted to the particular resources identified above and typically other resources will be located at hospitals, police departments, fire departments and coastal rescue stations not included in the list above.

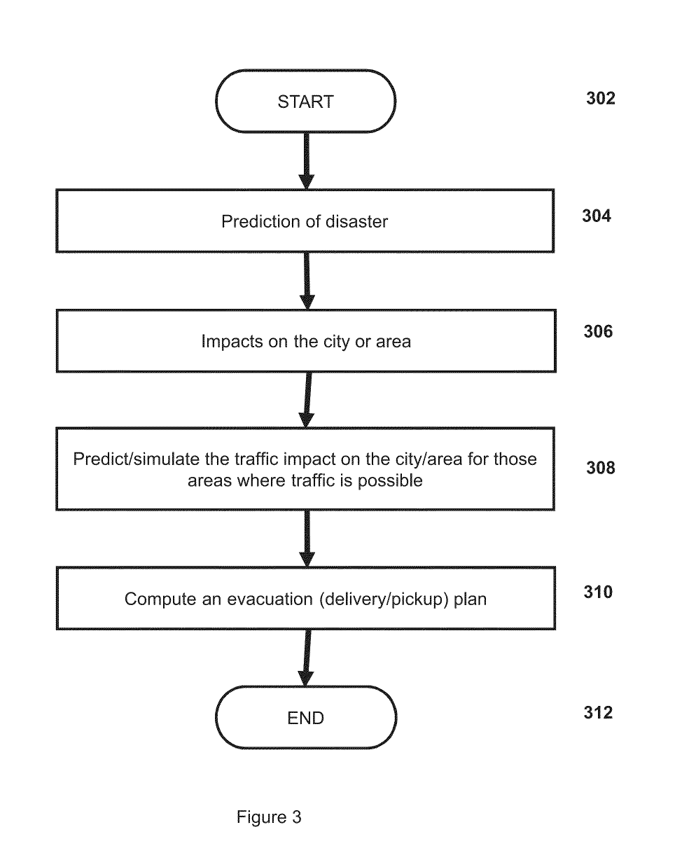

FIG. 3 shows a flowchart of the four basic steps of a disaster management system, the fourth step 310 being implemented in embodiments of the present invention. A method of disaster management starts at step 302. At step 304, prediction of a disaster is completed. This may include the type, scale and location of the disaster. At step 306, the impact of the disaster on the city or area is predicted. At step 308, the traffic impact on the city or area is predicted for those areas where traffic is possible. At step 310, embodiments of the present invention are used to compute an evacuation plan by, for example performing a method for planning relocation of people from disaster locations to safe locations. The method ends at step 312.

The stages involved in computing or generating an evacuation plan include receiving input information and calculating output information based on that input information.

The input information may include (i) the location at time zero of vehicles and emergency personnel; and (ii) a reasonably precise forecast of the emergencies which may arise, due to modelling the evolution of the catastrophe. These may include, for example, a fire extending in the direction of a prevailing wind or flooding evolving in accordance with a hydromechanics model. In one embodiment, the received input information includes an identification of: a plurality of disaster locations at which a respective disaster is predicted to occur, a number of persons to be evacuated during a specified range of time at each disaster location, a plurality of safe locations available for relocating the persons to be evacuated from the disaster locations, a plurality of vehicles available to transport the persons from the disaster locations to the safe locations, each vehicle's capacity of a maximum number of people that can be simultaneously transported, and each vehicle's current location.

In one embodiment, the computed or generated evacuation plan is an optimal plan for (i) evacuating the identified number of persons from the disaster locations during the respective specified ranges of time and (ii) transporting the evacuated persons to the safe locations.

The information output may be a calculation of the best way to use resources (vehicles and personnel) over the next N time periods, in order to maximize the benefits (number of saved people typically). This decision process may lead to a delay in using a resource at step n to allow it use it at step n+1 where it will be of higher benefit, but not degrading the response to the emergency at step n because it can be addressed by another less rare resource.

In one embodiment, generating the evacuation plan comprises utilizing the received identifications to determine, for each time interval of N successive time intervals such that N is at least 2: (a) a location of each vehicle relative to the disaster locations and the safe locations and (b) a number of persons in each disaster location, each vehicle, and each safe location, wherein all persons evacuated from the disaster locations have been relocated to the safe locations by elapse of the N time intervals.

Embodiments of the present invention use a Mixed Integer Programming (MIP) method in order to compute an evacuation (delivery/pickup) plan. It is desired to get the best schedule and use of resources to evacuate the people from unavailable “sections” of the city at disaster locations to available “sections” of the city, with an aim of avoiding a new concentration of people in the free sections (i.e., safe locations). Embodiments of the method handle any or all of (i) evacuation (pickup/delivery) of people who are in good health to free sections; (ii) evacuation (pickup/delivery) of people who are injured to free hospitals; (iii) evacuation (pickup/delivery) of people in a flooded hospital to a hospital which is not flooded; and (iv) redistribution of doctors, nurses and the like to an available hospital. Embodiments of the method take into account the average real-time traffic (real or predicted).

Thus in one embodiment, computing or generating the evacuation plan comprises performing mixed integer programming (MIP) utilizing the received identifications, as input, to determine, for each time interval of the N successive time intervals, (a) the location and movement of each vehicle relative to the disaster locations and the safe locations and (b) the number of persons in each disaster location, each vehicle, and each safe location.

In one embodiment, computing or generating the evacuation plan comprises performing stochastic linear programming utilizing the received identifications, as input, to determine, for each time interval of the N successive time intervals, (a) the location and movement of each vehicle relative to the disaster locations and the safe locations and (b) the number of persons in each disaster location, each vehicle, and each safe location.

Embodiments of the invention may operate in schedule mode, in which if the resources to achieve given objectives are given, then a shortest schedule is computed. In one embodiment, achieving the shortest schedule comprises minimizing a time at which all of the persons have been evacuated from the disaster locations.

Other embodiments of the invention may operate in a resource sizing mode in which if the time is given by when the evacuation has to be completed, then the smallest number of resources can be computed whilst still respecting the time constraints. In one embodiment, achieving the smallest number of resources comprises minimizing a total number of vehicles, selected from the plurality of available vehicles, utilized for traveling to the disaster locations for evacuating the identified number of persons from the disaster locations during the respective specified ranges of time and for transporting the evacuated persons to the safe locations.

In one embodiment, the evacuation plan minimizes a total distance collectively traveled by the vehicles for traveling to the disaster locations for evacuating the identified number of persons from the disaster locations during the respective specified ranges of time and for transporting the evacuated persons to the safe locations.

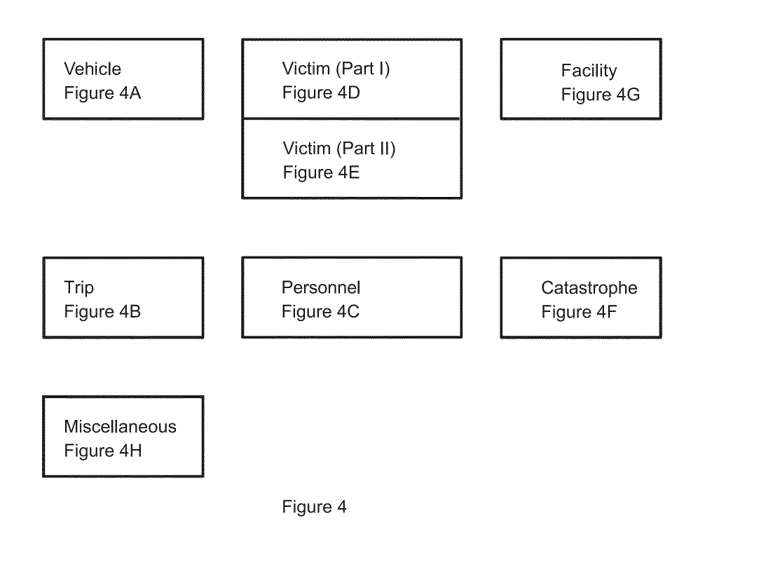

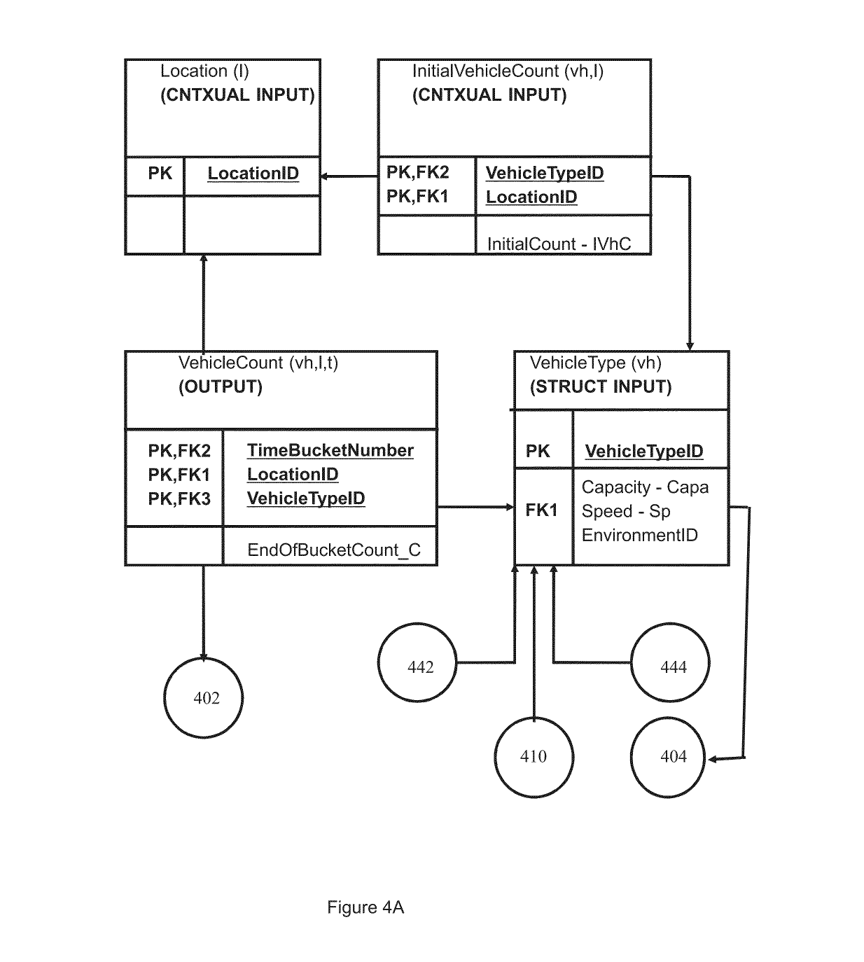

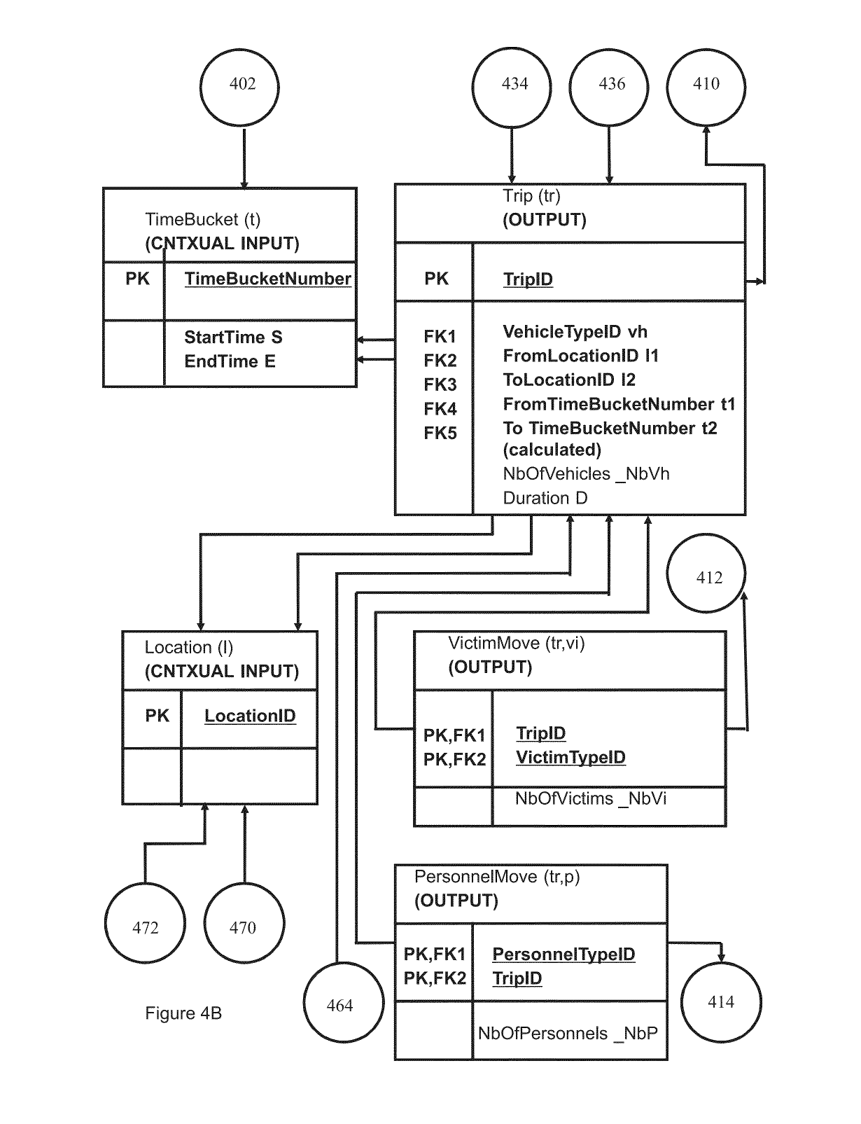

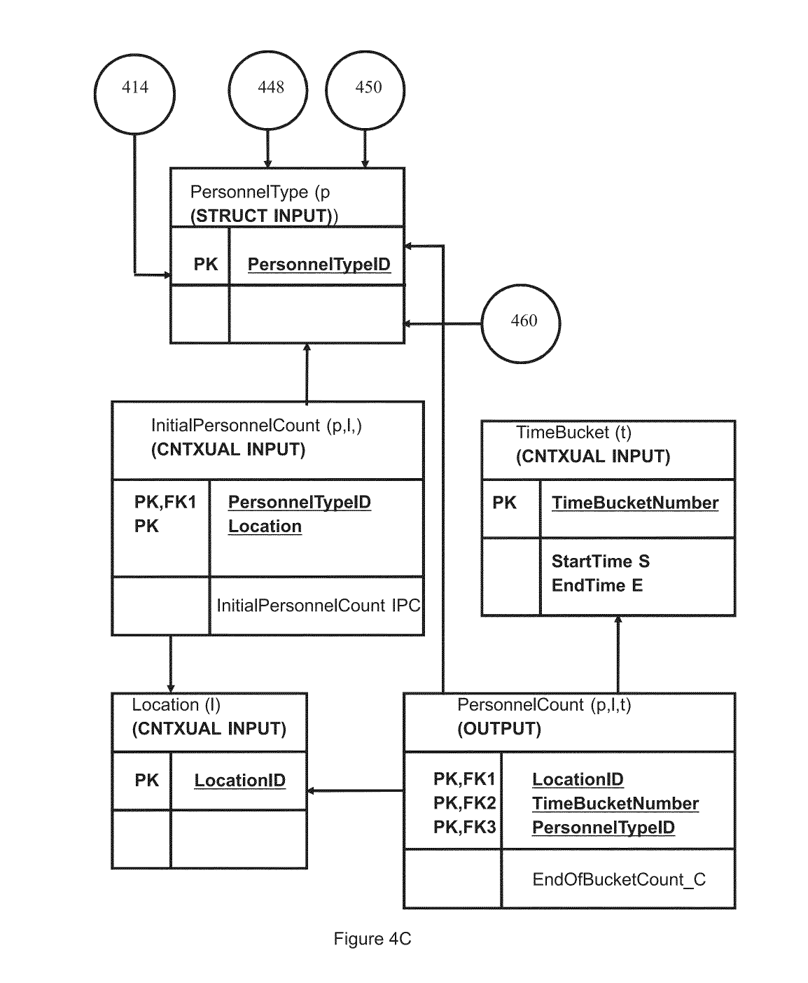

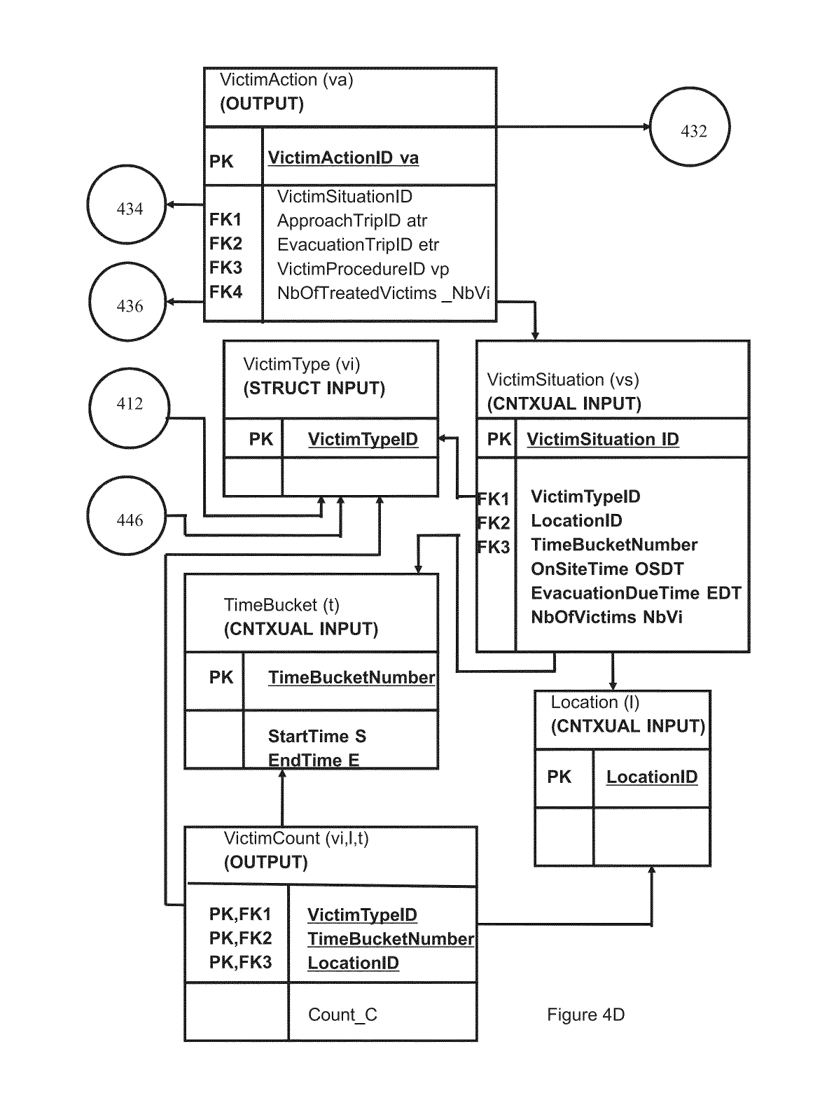

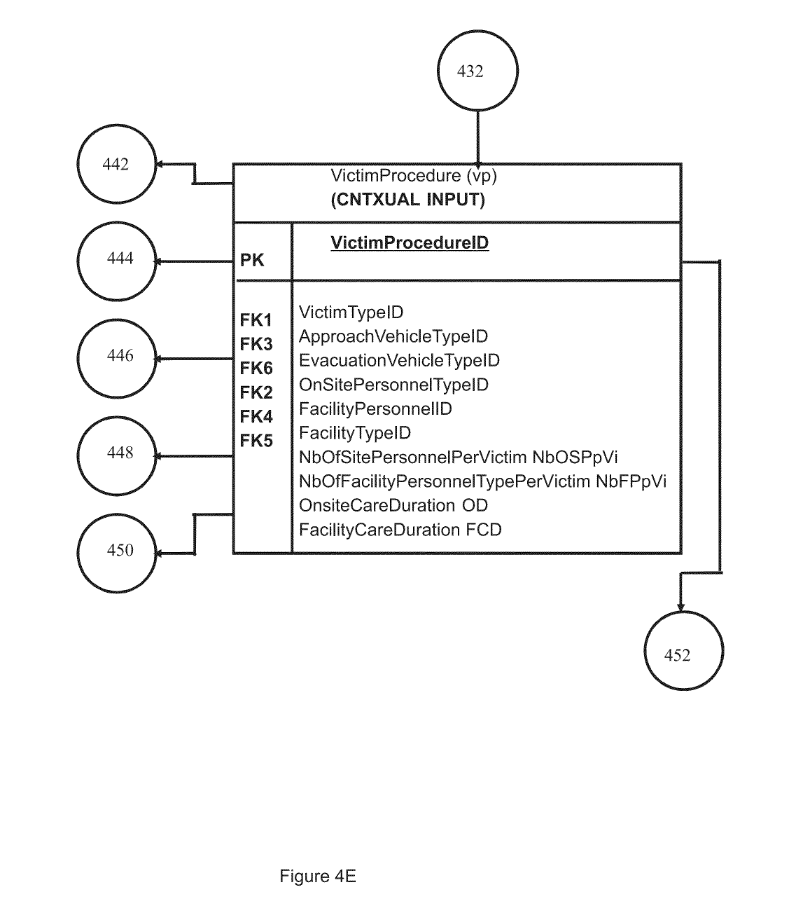

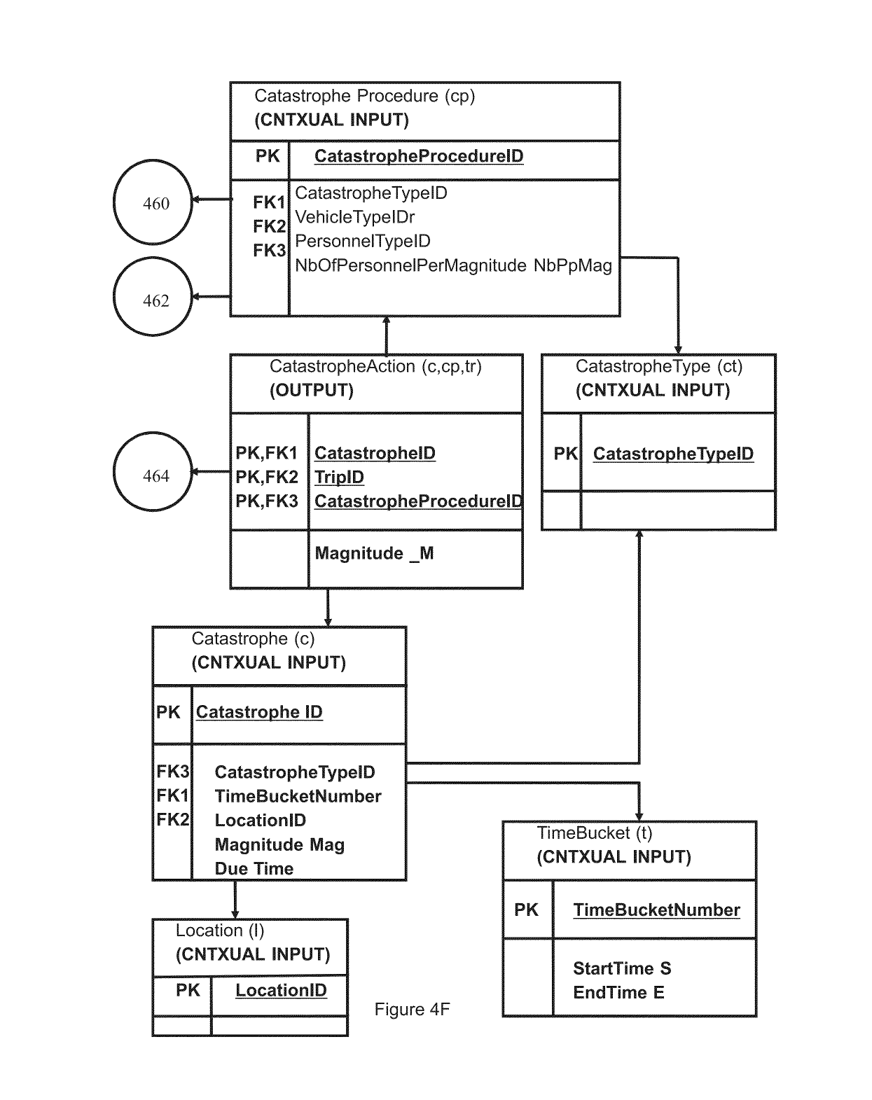

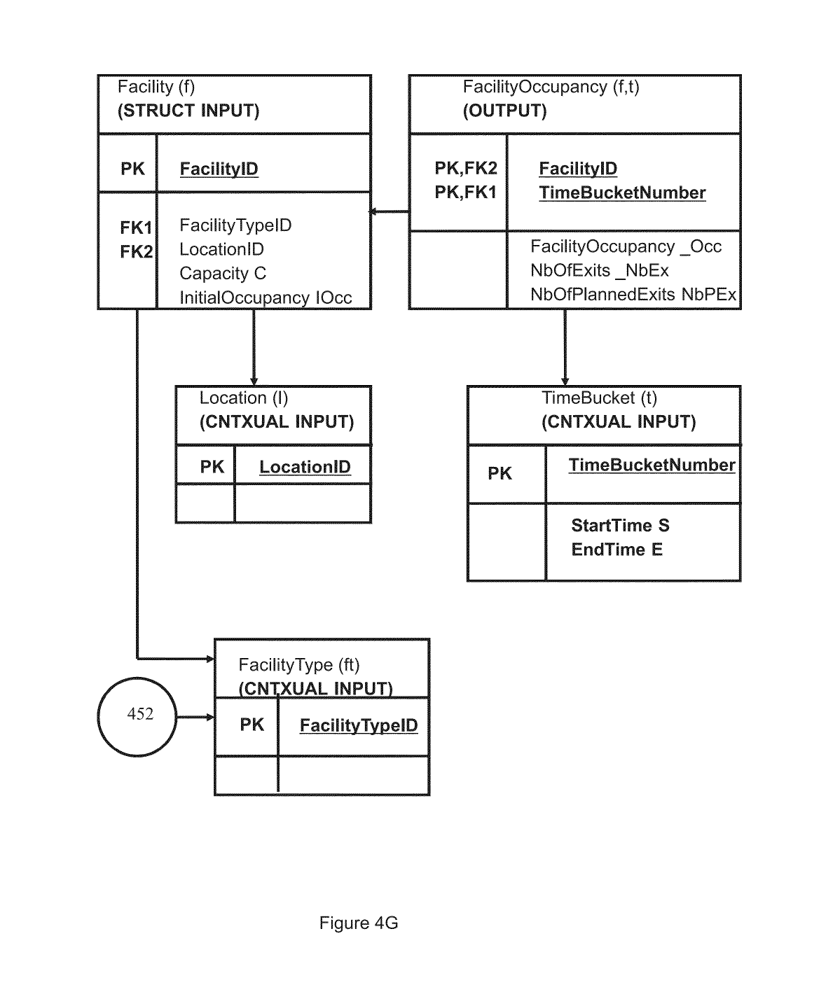

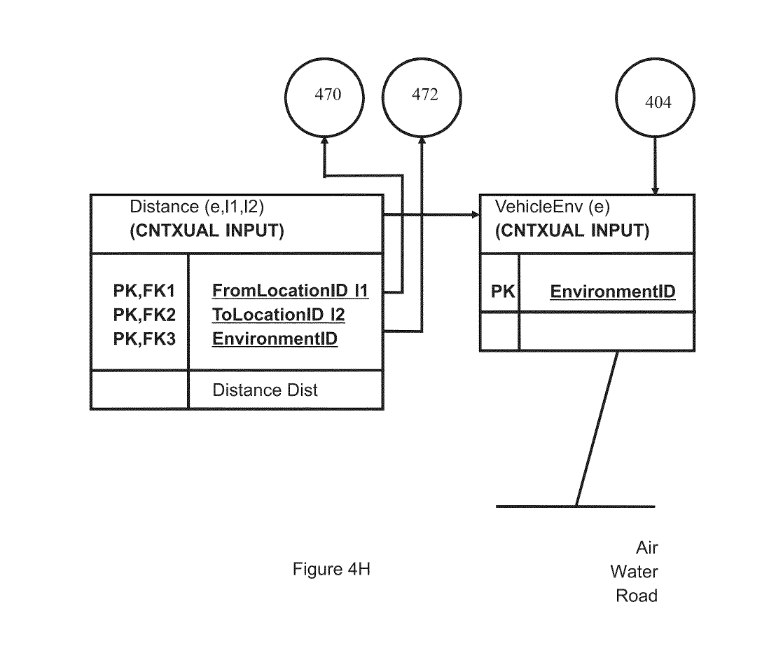

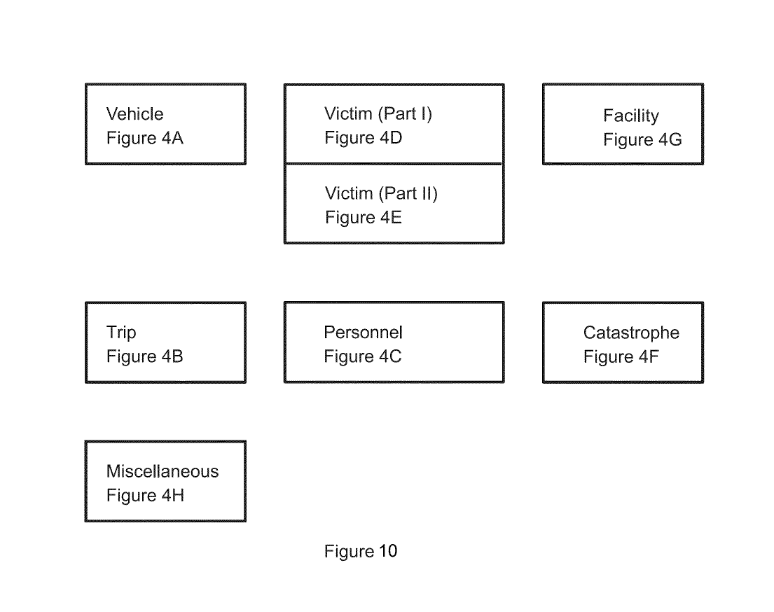

FIG. 10 depicts an Entity-Relationship model which shows the arrangement of FIGS. 4A to 4H which are each portions of an Entity-Relationship data model used in embodiments of the present invention. Items in FIGS. 4A to 4H may be contextual input (identified by the text “CNTXUAL INPUT” under their data model name), structural input (identified by the text “STRUCT INPUT” under their data model name) and output (identified by the text “OUTPUT” under their data model name). All input attributes have their data model name (example “Speed” in data model VehicleType in FIG. 4A is an input, NbOfVehicles in data model Trip in FIG. 4B is an output) followed by their mathematical name (example Sp is a mathematical constant,_NbVh is a mathematical variable—note the underscore notation).

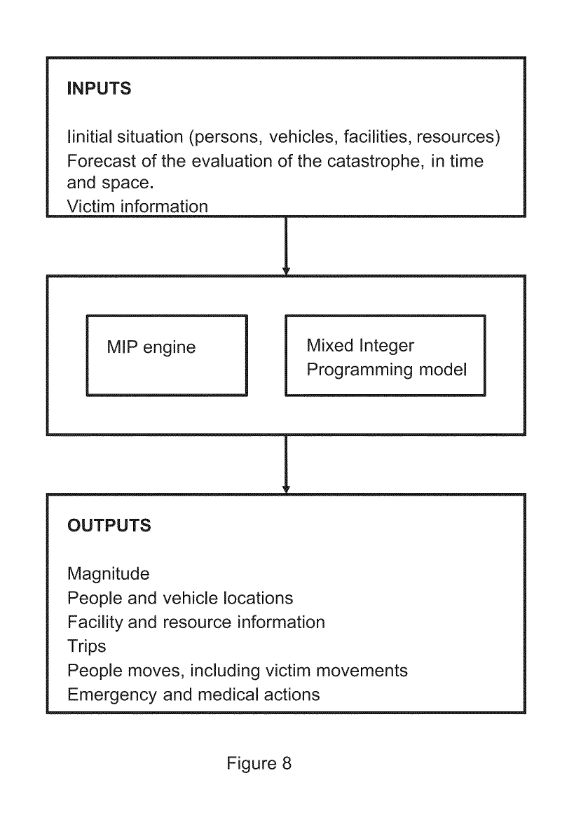

Embodiments of the present invention also include a Mixed Integer Programming (MIP) mathematical model, which can be run by any MIP engine. An exemplary embodiment is shown in FIG. 8. An example of such an MIP engine is IBM/ILOG/CPLEX (IBM, ILOG and CPLEX are trademarks of International Business Machines Corp.). Such MIP engines automate complex decisions and trade-offs of limited resources. Another example of an MIP engine is the GNU Linear programming Kit (GLPK).

In an embodiment the combination of the Entity Relationship data model and the MIP engine receives as inputs, the initial situation (persons, vehicles, resources), a forecast of the evaluation of the catastrophe, in time and space and victim information. It provides as outputs, magnitude, people and vehicle locations, facility and resource information, trips, people moves including victim movements, emergency and medical actions, planned over a certain geographic perimeter, and for a given time horizon (typically next 12 hours, hour by hour).

For each possible victim situation, approach trip, evacuation trip, victim procedure: the number of treated victims is output.

For each possible trip: the number of involved vehicles and the duration of the trip is output.

For each possible trip, type of personnel or type victim: the number of this type of person achieving this trip is output.

For each possible time period, resource (persons, vehicles, material), location: the count of resources at the end of the time period, at this location is output.

For each possible catastrophe, time, trip, catastrophe procedure: the magnitude of the performed action is output.

For each facility (building), time period: the occupancy, Number of exits, number of entrances (admissions) is output.

Referring to FIG. 4A, data associated with a “vehicle” entity are shown. The “vehicle” entity represents a data object about which information is collected and stored. A Primary Key (PK) is a key that is used to identify entities and to access records. A Foreign Key (FK) is an attribute that is the Primary Key of another data structure and is used to establish a relationship with that data structure where it appears as an attribute as well. A structural input, VehicleType, has a PK of VehicleTypeID and a FK of Capacity, Speed and Environment. A contextual input, Location, has a PK of LocationID. Another contextual input, InitialVehicleCount, has PKs and FKs of VehicleTypeID and LocationID. It also has a variable, InitialCount-IVhC, associated with it. An output, VehicleCount, has PK and FKs of TimeBucketNumber, LocationID and VehicleTypeID. It also has a variable, EndOfBucketCount C, associated with it.

Referring to FIG. 4B, data associated with a “trip” entity are shown. A contextual input, TimeBucket, has a PK of TimeBucketNumber. It also has variables, StartTime S and EndTime E, associated with it. Another contextual input, Location, has a PK of LocationID. An output, Trip, has a PK of TripID and FKs of VehicleTypeID vh, FromLocationID I1, ToLocationID I2, FromTimeBucketNumber t1 and ToTimeBucketNumber t2 (calculated). It also has variables, NbOfVehicles_NbVh and Duration D, associated with it. Another output, VictimMove, has PK and FKs of TripID and VictimTypeID. It also has a variable, NbOfVictims_NbVi, associated with it. Another output, PersonnelMove, has PK and FKs of PersonnelTypeID and TripID. It also has a variable, NbOfPersonnels_NbP, associated with it.

Referring to FIG. 4C, data associated with a “personnel” entity are shown. A structural input, PersonnelType, has a PK of PersonnelType. A contextual input, InitialPersonnelCount, has a PK of Location and a PK and FK of PersonnelTypeID. It also has a variable, InitialPersonnelCount IPC, associated with it. A contextual input, TimeBucket, has a PK of TimeBucketNumber. It also has variables, StartTime S and EndTime E, associated with it. A contextual input, Location, has a PK of LocationID. An output, PersonnelCount, has PK and FKs of LocationID, TimeBucketNumber and PersonnelTypeID. It also has a variable, EndOfBucketCount C, associated with it.

Referring to FIGS. 4D and 4E, data associated with a “victim” entity are shown. Shown in FIG. 4D is a structural input, VictimType, which has a PK of VictimTypeID. A contextual input, VictimSituation, has a PK of VictimSituationID. It has FKs of VictimTypeID, LocationID and TimeBucketNumber. It also has variables, OnSiteTime OSDT, EvacuationDueTime EDT and NbOfVictims NbVi, associated with it. A contextual input, TimeBucket, has a PK of TimeBucketNumber. It also has variables, StartTime S and EndTime E, associated with it. A contextual input, Location, has a PK of LocationID. An output, VictimAction, which has a PK of VictimActionID va and FKs of VictimSituationID, ApproachTripID atr, EvacuationTripID etr andVictimProcedureID vp. It has a variable NbOfTreatedVictims_NbVi associated with it. An output, VictimCount, has PKs and FKs of VictimTypeID, TimeBucketNumber and LocationID. It also has a variable, Count_C, associated with it.

Shown in FIG. 4E is a contextual input, VictimProcedure, which has a PK of VictimProcedureID and FKs of VictimTypeID, ApproachVehicleTypeID, EvacuationVehicleTypeID, OnSitePersonnelTypeID, FacilityPersonnelID and FacilityTypeID. It also has variables, NbOfSitePersonnelPerVictim NbOSPpVi, NbOfFacilityPersonnelTypePerVictim NbFPpVi, OnsiteCareDuration OD and FacilityCareDuration FCD, associated with it.

Referring to FIG. 4F, data associated with a “catastrophe” entity are shown. A contextual input, Catastrophe Procedure, has a PK of CatastropheProcedureID and FKs of CatastropheTypeID, VehicleTypeIDr andPersonnelTypeID. It also has a variable, NbOfPersonnelPerMagnitude NbPpMag associated with it. A contextual input, CatastropheType, has a PK of CatastropheTypeID. A contextual input, Catastrophe, has a PK of Catastrophe ID and FKs of CatastropheTypeID, TimeBucketNumber and LocationID. It also has variables, Magnitude Mag and Due Time, associated with it. A contextual input, Location, has a PK of LocationID. A contextual input, TimeBucket, has a PK of TimeBucketNumber. It also has variables, StartTime S and EndTime E associated with it. An output, CatastropheAction, has PK and FKs of CatastropheID, TripID and CatastropheProcedureID. It also has a variable, Magnitude_M associated with it.

Referring to FIG. 4G, data associated with a “facility” entity are shown. A structural input, Facility, has a PK of FacilityID and FKs of FacilityTypeID and LocationID. It also has variables, Capacity C and InitialOccupancy IOcc, associated with it. A contextual input, Location, has a PK of LocationID. A contextual input, TimeBucket, has a PK of TimeBucketNumber. It also has variables, StartTime S and EndTime E, associated with it. A contextual input, FacilityType, has a PK of FacilityTypeID. An output, FacilityOccupancy, has PK and FKs of FacilityID and TimeBucketNumber. It also has variables, FacilityOccupancy_Occ, NbOfExits_NbEx and NbOfPlannedExits NbPEx, associated with it.

Referring to FIG. 4H, data associated with a “miscellaneous” entity are shown. A contextual input, Distance, has PKs and FKs of FromLocationID I1, ToLocationID I2 and EnvironmentID. It also has a variable, Distance Dist associated with it. A contextual input, VehicleEnv, has a PK of EnvironmentID.

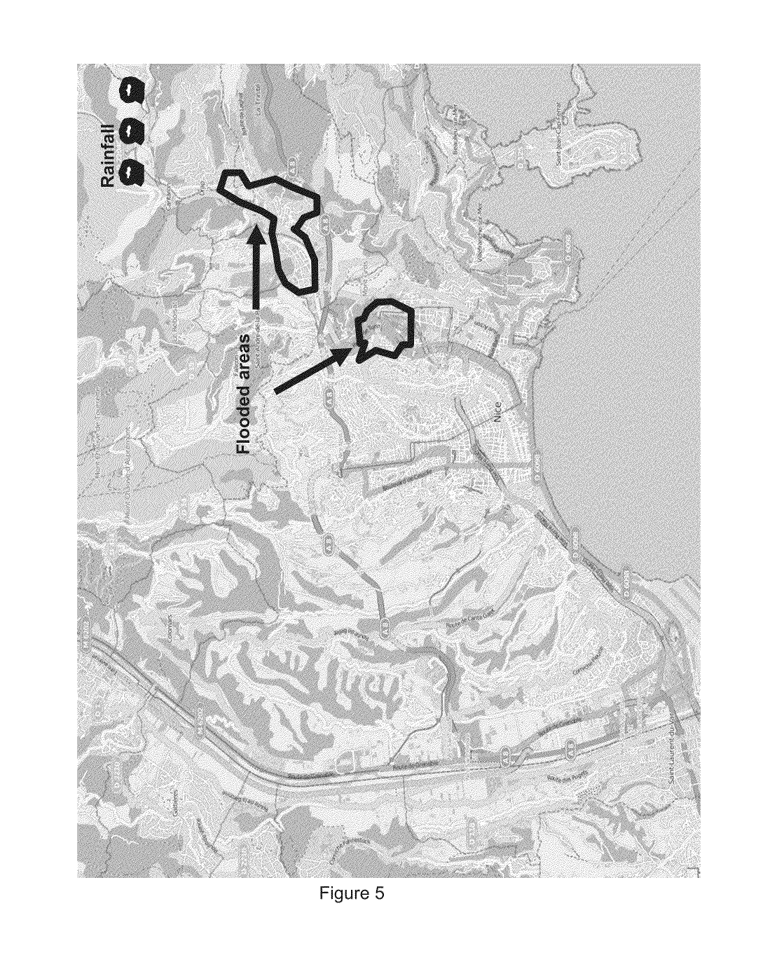

Referring to FIG. 5, the map of FIG. 1 is annotated at the top right of the map with indications of areas where there has been heavy rainfall, in accordance with embodiments of the present invention. This results in the river or rivers into which the rainfall drains into flooding areas adjacent to the river or rivers. These are shown as the flooded areas in FIG. 5.

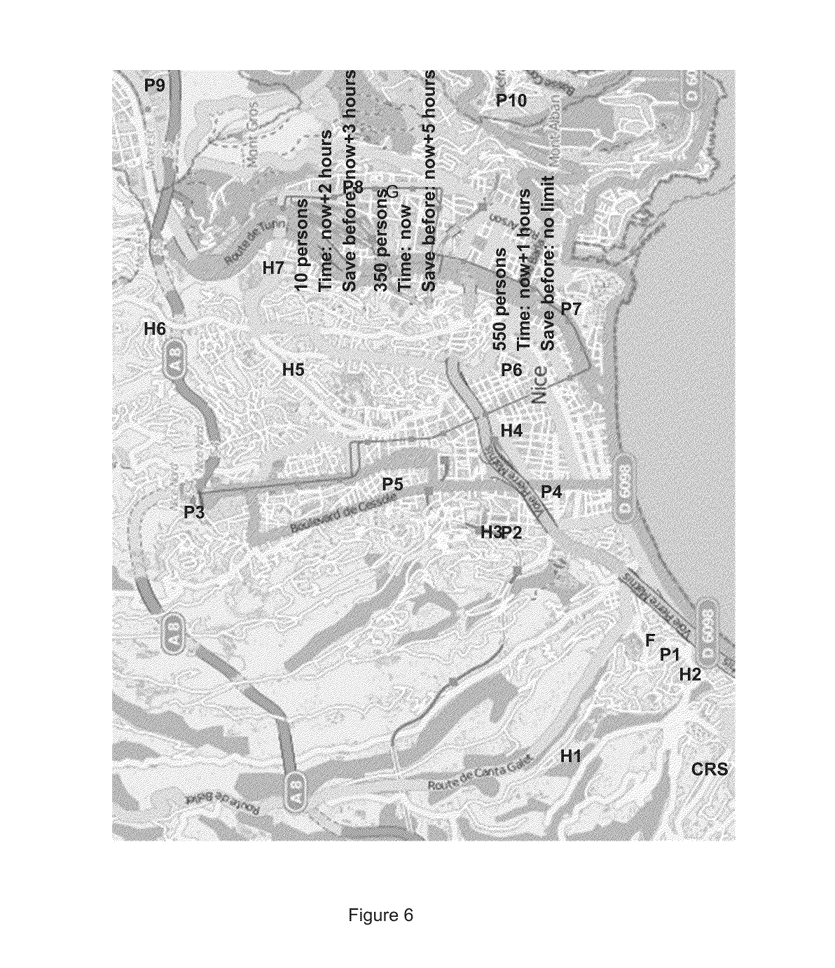

Referring to FIG. 6, Coast Rescue Stations, Fire department, Police departments and Hospitals are shown as described above with reference to FIG. 2, in accordance with embodiments of the present invention. The objectives of the evacuation plan are to evacuate civilians in the flooded area and to evacuate patients from hospitals that may be affected by the flooding to hospitals that will remain unaffected by the flooding. The doctors and nurses at those hospitals will also need to be evacuated from the hospitals that may be affected by the flooding to hospitals that will remain unaffected by the flooding. The model for an evacuation plan may include real time road traffic data. The model for the evacuation plan handles all of the resources from the fire department, police department and any army resources and allocates them in the optimal way for the evacuation.

In FIG. 6 there are shown three groups of people at disaster locations (A8) who require assistance. A first group of 350 people are identified now as needing assistance, but they need to be given the assistance between now and 5 hours' time. A second group of 550 people are identified one hour after the disaster as needing assistance, but they have no latest time by which they must be given assistance. A third group of 10 people are identified two hours after the disaster as needing assistance, but they need to be given the assistance between two hours after and three hours after the disaster. The evacuation plan takes into account the deadlines by which assistance must be given. In one embodiment, the assistance needed includes evacuation of the three groups of peoples from the disaster locations A8 and transporting the evacuated three groups of people from the disaster locations A8 to safe locations.

The example of FIG. 6 illustrates an embodiment in which the number of disaster locations are at least three disaster locations.

### Exemplary Mixed Integer Programming (MIP) Mathematical Model

### Notation Conventions:

Constant symbols can be shared if they do not share the same signature.

Example: C(vi,l,t) vs C(vh,l,t)

Variables begin with underscore:

Example: _C(vi,l,t)

Arithmetic on time buckets is noted in the following manner:

t1+duration=t2

meaning

t2 is the biggest interval intersection: [s(t1)+d,e(t1)+d]

Calculation of trip's “ToTimeBucketNumber”

### Calculated Values

t2(tr)=t1(tr)+duration(tr)+D

D(tr)=D(e(vh(tr)),l1(tr),l2(tr))·Sp(vh(tr))

All variables are positive
In particular, this addresses the conservation of the number of vehicles, personnel, victims

### Constraints

### Victim Count:

_{—}C(vi,l,0)=Sum(vs/vi(vs)=vi&&1(vs)=1&&t(vs)=0)NbVi(vs)//initial count

_{—}C(vi,l,t+1)=

_{—}C(vi,l,t)

+Sum(tr/t2=t+1)NbVi(tr,vi)//input

−Sum(tr/t1=t+1)NbVi(tr,vi)//output

+Sum(vs/vi(vs)=vi&&t(vs)=t&& 1(vs)=1)NbVi(vs)//new victim situations coming on the fly

### Personnel Count:

_{—}C(p,l,0)=IPC(p,l)

_{—}C(p,l,t+1)=

_{—}C(p,l,t)

+Sum(tr/t2=t+1)_{—}NbP(tr,p)

−Sum(tr/t1=t+1)_{—}NbP(tr,p)

### Vehicle Count:

_{—}C(vh,l,0)=IVhC(vh,l)

_{—}C(vh,l,t+1)=

_{—}C(vh,l,t)

+Sum(tr/vh(tr)=vh&&12=1)_{—}NbVh(tr)//input

−Sum(tr/vh(tr)=vh&&11=1)_{—}NbVh(tr)//output

### Facility Occupancy:

_{—}Occ(f,0)=IOcc(f)

_{—}Occ(f,t+1)=

_{—}Occ(f,t)

+Sum(tr,vi/l2(tr))=1(f))NbVi(tr,vi)

−Sum(tr,vi/l1(tr))=f(f))NbVi(tr,vi)//this number is likely to be equal to zero

−_{—}NbEx(f,t+1)

NbEx(f,t)=

NbPEx(f,t)//planned exits

+Sum(va/l2(etr(va))=1(f)&&t2(etr(va))+FCD(vp(va))=t)_{—}NbVi(va)

### Facility Capacity:

_{—}Occ(f,t)<=C(f)

### Objectives:

address victims and catastrophes

Minimize lateness, minimize non addressed issues (victims/catastrophes)

### Simplified Example

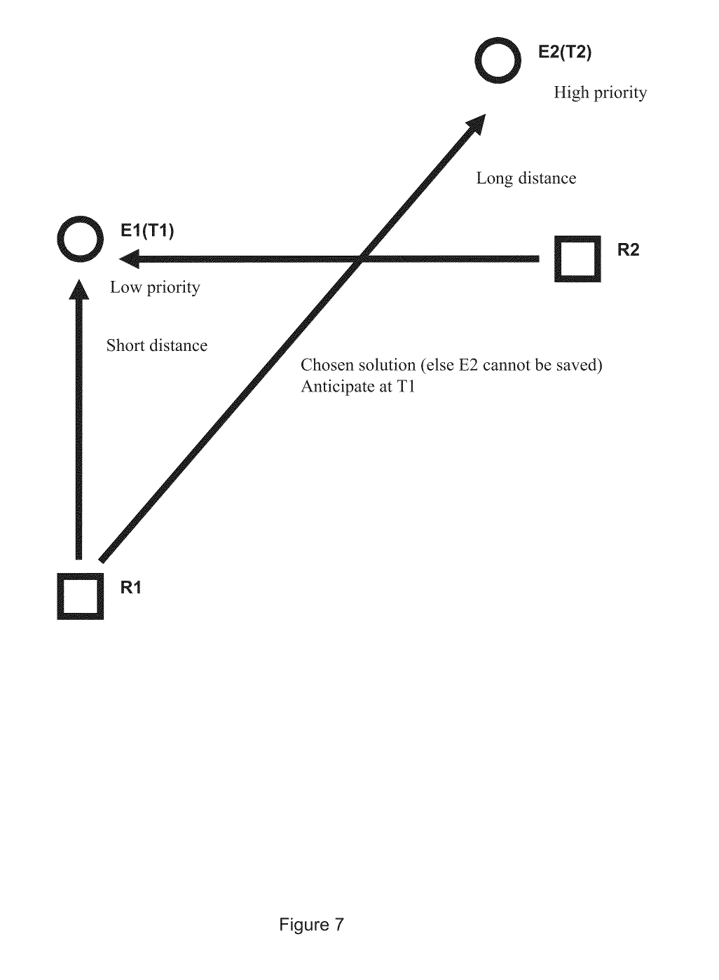

Referring to FIG. 7, the situation in a simplified example is that resources R1, R2 are evacuation vehicles V1, V2 with drivers, in accordance with embodiments of the present invention. Vehicle V1 has a capacity of 20 and vehicle V2 has a capacity of 10.

There is an emergency at E1 with 10 persons present at T1, but in a situation that is not deteriorating. There is also an emergency at E2 with 20 persons anticipated at T2, but it is a high priority emergency as 20 persons are now trapped in a building with flood water rising. They will be dead by T3 if they are not evacuated.

There are at least three possible solutions to resolution of the two emergencies.

Solution 1—At time T1, resource R1, with a capacity of 20 persons, travels the short distance to emergency E1, takes on 10 persons at E1, and then travels in anticipation to emergency E2 with the 10 people taken on at E1. However, resource R1 now arrives at emergency E2 too late. At time T2, resource R2 travels to emergency E2, but is only able to take on 10 of the 20 people. The remaining 10 die in emergency E2.

Solution 2—At time T1, resource R1, with a capacity of 20 persons, travels the short distance to emergency E1, takes on 10 persons at E1, and does not attend emergency E2. At time T1, resource R2, with a capacity of 10 persons, travels the short distance to emergency E2, takes on 10 persons at E2, who are saved. The other 10 persons at emergency E2 are not saved.

Solution 3—At time T1, resource R1, with a capacity of 20 persons, travels the longer distance to emergency E2 in anticipation, takes on 20 persons and evacuates them in time. Resource R2, with a capacity of 10 persons, travels to emergency E1 and does not arrive until time T2. However, this does not matter since the situation is not deteriorating. This is the preferred solution and is chosen.

In preferred embodiments of the invention, multiple time periods are used, with particular embodiments using periods of 30 minutes or one hour for each time period. Preferred embodiments also have many possible victim actions and victim situations as well as catastrophe types and catastrophe procedures. Preferred embodiments further have multiple vehicle types, emergency personnel types, personnel skills and facility types.

Embodiments of the present invention provide at least some of the following advantages.

The embodiments take into account a time phased based forecast of the evolution of the catastrophe, as opposed to the prior art generally used history independent forecast.

The embodiments provide a calculation of anticipated needed moves of resources and people from catastrophe places to secure facilities (such as hospitals and refuge places), as opposed to the generally used calculation of proximity waiting places for resources (doctors, nurses, vehicles and drivers), and then, at crisis time, trigger the closest resources for rescuing endangered people. For example, a choice can be made to wait to move resources during the first hour (which is locally sub-optimal), in anticipation of a need of those resources in the next hour (which is globally optimal).

The embodiments provide an unlimited number of catastrophe points, as opposed to the prior art arbitration of two locations.

Embodiments provide a guarantee of quasi optimality of the solution (due to the use of a MIP algorithm), as opposed to the prior art generally used sub-optimal heuristics.

Embodiments provide a connection between the solution and a monitoring system, in order to recalculate resources moves if the actual observed events deviate from the forecast events.

Embodiments provide independence of human resources from material resources (typically drivers/ambulance crew and vehicles) in order to optimally use human resources skills dependently of the catastrophe situation, as opposed to the prior art of a team attached to their material, such as vehicles or facilities.

Embodiments provide a possibility to account for forecast variability, by extending the mathematical model to stochastic linear programming.

Embodiments provide the possibility to allow local decision making in a case of deterioration of communication, or of an unexpected critical situation being experienced (degraded situation: ignored lost communication resources). Embodiments also allow the resource assignment algorithm to be re-launched in real-time when communication is recovered, or when information of criticality is recovered and re-entered in calculation system.

Embodiments of the invention can take the form of a computer program accessible from a computer-usable or computer-readable storage medium or device providing program code for use by or in connection with a computer or any instruction execution system. For the purposes of this description, a computer usable or computer storage readable medium or device can be any apparatus that can store the program for use by or in connection with the instruction execution system, apparatus or device.

The storage medium or device can be an electronic, magnetic, optical, electromagnetic, or semiconductor system (or apparatus or device). Examples of a computer-readable storage medium or device include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-RW), and DVD.

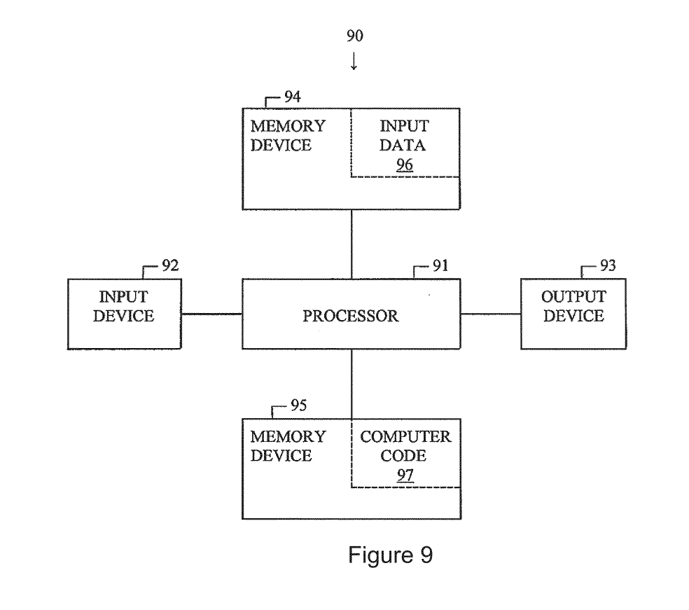

FIG. 9 illustrates a computer system used for implementing methods of the present invention, in accordance with the embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, a keypad, a touch screen, a scanner, a voice recognition device, a sensor, a network interface card (NIC), a Voice/video over Internet Protocol (VOIP) adapter, a wireless adapter, a telephone adapter, a dedicated circuit adapter, etc. The output device 93 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes computer program code 97 which is a computer program that comprises computer-executable instructions. The program code 97 includes software or program instructions that may implement methods of the present invention. The processor 91 executes the program code 97. The memory device 94 includes input data 96. The input data 96 includes input required by the program code 97. The output device 93 displays output from the program code 97. Either or both memory devices 94 and 95 (or one or more additional memory devices not shown in FIG. 9) may be used as a computer readable storage medium or device (or program storage device) having a computer readable program embodied therein and/or having other data stored therein, wherein the computer readable program comprises the program code 97. Generally, a computer program product (or, alternatively, an article of manufacture) of the computer system 90 may comprise said computer readable storage medium (or said program storage device). A computer readable storage device of the present invention, when storing the program code 97 for execution by one or more processors, is not a transmission medium such as a copper transmission cable, an optical transmission fiber, or a wireless transmission medium.

While FIG. 9 shows the computer system 90 as a particular configuration of hardware and software, any configuration of hardware and software, as would be known to a person of ordinary skill in the art, may be utilized for the purposes stated supra in conjunction with the particular computer system 90 of FIG. 9. For example, the memory devices 94 and 95 may be portions of a single memory device rather than separate memory devices. As another example, the processor 91 may represent one or more processors, and each memory device of memory devices 94 and 95 may represent one or more memory devices and/or one or more computer readable storage devices.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for planning relocation of people from disaster locations to safe locations, said method comprising:
receiving, by a processor of a computer system, an identification of: a plurality of disaster locations at which a respective disaster is predicted to occur, a number of persons to be evacuated during a specified range of time at each disaster location, a plurality of safe locations available for relocating the persons to be evacuated from the disaster locations, a plurality of vehicles available to transport the persons from the disaster locations to the safe locations, each vehicle's capacity of a maximum number of people that can be simultaneously transported, and each vehicle's current location; and
generating, by the processor, an optimal plan for (i) evacuating the identified number of persons from the disaster locations during the respective specified ranges of time and (ii) transporting the evacuated persons to the safe locations,
said generating the plan comprising utilizing the received identifications, as input, to determine, for each time interval of N successive time intervals such that N is at least 2: (a) a location of each vehicle relative to the disaster locations and the safe locations and (b) a number of persons in each disaster location, each vehicle, and each safe location,
wherein all persons evacuated from the disaster locations have been relocated to the safe locations by elapse of the N time intervals.

2. The method of claim 1, wherein said generating the plan comprises performing mixed integer programming (MIP) utilizing the received identifications to determine, for each time interval of the N successive time intervals, (a) the location and movement of each vehicle relative to the disaster locations and the safe locations and (b) the number of persons in each disaster location, each vehicle, and each safe location.

3. The method of claim 1, wherein said generating the plan comprises performing stochastic linear programming utilizing the received identifications to determine, for each time interval of the N successive time intervals, (a) the location and movement of each vehicle relative to the disaster locations and the safe locations and (b) the number of persons in each disaster location, each vehicle, and each safe location.

4. The method of claim 1, wherein the plan minimizes a time at which all of the persons have been evacuated from the disaster locations.

5. The method of claim 1, wherein the plan minimizes a total distance collectively traveled by the vehicles for traveling to the disaster locations for evacuating the identified number of persons from the disaster locations during the respective specified ranges of time and for transporting the evacuated persons to the safe locations.

6. The method of claim 1, wherein the plan minimizes a total number of vehicles, selected from the plurality of available vehicles, utilized for traveling to the disaster locations for evacuating the identified number of persons from the disaster locations during the respective specified ranges of time and for transporting the evacuated persons to the safe locations.

7. The method of claim 1, wherein the plurality of disaster locations comprises at least three disaster locations.

8. A computer program product, comprising a computer readable storage device having a computer readable program code stored therein, said program code containing instructions which, upon being executed by a processor of a computer system, implement a method for planning relocation of people from disaster locations to safe locations, said method comprising:
receiving, by the processor, an identification of: a plurality of disaster locations at which a respective disaster is predicted to occur, a number of persons to be evacuated during a specified range of time at each disaster location, a plurality of safe locations available for relocating the persons to be evacuated from the disaster locations, a plurality of vehicles available to transport the persons from the disaster locations to the safe locations, each vehicle's capacity of a maximum number of people that can be simultaneously transported, and each vehicle's current location; and
generating, by the processor, an optimal plan for (i) evacuating the identified number of persons from the disaster locations during the respective specified ranges of time and (ii) transporting the evacuated persons to the safe locations,
said generating the plan comprising utilizing the received identifications, as input, to determine, for each time interval of N successive time intervals such that N is at least 2: (a) a location of each vehicle relative to the disaster locations and the safe locations and (b) a number of persons in each disaster location, each vehicle, and each safe location,
wherein all persons evacuated from the disaster locations have been relocated to the safe locations by elapse of the N time intervals.

9. The computer program product of claim 8, wherein said generating the plan comprises performing mixed integer programming (MIP) utilizing the received identifications to determine, for each time interval of the N successive time intervals, (a) the location and movement of each vehicle relative to the disaster locations and the safe locations and (b) the number of persons in each disaster location, each vehicle, and each safe location.

10. The computer program product of claim 8, wherein said generating the plan comprises performing stochastic linear programming utilizing the received identifications to determine, for each time interval of the N successive time intervals, (a) the location and movement of each vehicle relative to the disaster locations and the safe locations and (b) the number of persons in each disaster location, each vehicle, and each safe location.

11. The computer program product of claim 8, wherein the plan minimizes a time at which all of the persons have been evacuated from the disaster locations.

12. The computer program product of claim 8, wherein the plan minimizes a total distance collectively traveled by the vehicles for traveling to the disaster locations for evacuating the identified number of persons from the disaster locations during the respective specified ranges of time and for transporting the evacuated persons to the safe locations.

13. The computer program product of claim 8, wherein the plan minimizes a total number of vehicles, selected from the plurality of available vehicles, utilized for traveling to the disaster locations for evacuating the identified number of persons from the disaster locations during the respective specified ranges of time and for transporting the evacuated persons to the safe locations.

14. The computer program product of claim 8, wherein the plurality of vehicles comprises ambulances, buses, cars, and a helicopter.

15. A computer system comprising a processor, a memory coupled to the processor, and a computer readable storage device coupled to the processor, said storage device containing program code which, upon being executed by the processor via the memory, implements a method for planning relocation of people from disaster locations to safe locations, said method comprising:
receiving, by the processor, an identification of: a plurality of disaster locations at which a respective disaster is predicted to occur, a number of persons to be evacuated during a specified range of time at each disaster location, a plurality of safe locations available for relocating the persons to be evacuated from the disaster locations, a plurality of vehicles available to transport the persons from the disaster locations to the safe locations, each vehicle's capacity of a maximum number of people that can be simultaneously transported, and each vehicle's current location; and
generating, by the processor, an optimal plan for (i) evacuating the identified number of persons from the disaster locations during the respective specified ranges of time and (ii) transporting the evacuated persons to the safe locations,
said generating the plan comprising utilizing the received identifications, as input, to determine, for each time interval of N successive time intervals such that N is at least 2: (a) a location of each vehicle relative to the disaster locations and the safe locations and (b) a number of persons in each disaster location, each vehicle, and each safe location,
wherein all persons evacuated from the disaster locations have been relocated to the safe locations by elapse of the N time intervals.

16. The computer system of claim 15, wherein said generating the plan comprises performing mixed integer programming (MIP) utilizing the received identifications to determine, for each time interval of the N successive time intervals, (a) the location and movement of each vehicle relative to the disaster locations and the safe locations and (b) the number of persons in each disaster location, each vehicle, and each safe location.

17. The computer system of claim 15, wherein said generating the plan comprises performing stochastic linear programming utilizing the received identifications to determine, for each time interval of the N successive time intervals, (a) the location and movement of each vehicle relative to the disaster locations and the safe locations and (b) the number of persons in each disaster location, each vehicle, and each safe location.

18. The computer system of claim 15, wherein the plan minimizes a time at which all of the persons have been evacuated from the disaster locations.

19. The computer system of claim 15, wherein the plan minimizes a total distance collectively traveled by the vehicles for traveling to the disaster locations for evacuating the identified number of persons from the disaster locations during the respective specified ranges of time and for transporting the evacuated persons to the safe locations.

20. The computer system of claim 15, wherein the plan minimizes a total number of vehicles, selected from the plurality of available vehicles, utilized for traveling to the disaster locations for evacuating the identified number of persons from the disaster locations during the respective specified ranges of time and for transporting the evacuated persons to the safe locations.
